(19) United States
(12) Patent Application Publication
(10) Pub. No.: US 2004/0049377 A1
(43) Pub. Date: Mar. 11, 2004

(54) Speech to data converter

(76) Inventor: D Gene O'Quinn, Houston, TX (US)

Correspondence Address: Dwayne L Mason, Akin Gump Strauss Hauer & Feld, Suite 1900, 711 Louisiana, Houston, TX, 77002, US

(21) Appl. No.: 10/398,642

(22) PCT Filed: Oct. 5, 2001
(86) PCT No.: PCT/US01/42526

(51) Int. Cl. G10L 19/02

(52) U.S. Cl. 704/203

(57) ABSTRACT

Method and apparatus for reducing the amount of data sent when transmitting speech by obtaining the spectrum content of digital speech (406). First, analog speech is converted to digital speech (406). Then the digital speech is divided into frames and a spectrum analysis is performed on the frames (408). Frames with similar spectrum are combined (410). Then a second spectrum analysis is performed in predetermined steps (412). The data from the spectrum analysis of each frame is compressed and sent to a receiver (414). The receiver uses the data to reconstruct the frame (418). The frame is combined with other frames to reproduce the digital, signal (420). Then the digital signal is played back, thereby reproducing the analog speech (422).

This application claims the benefit of U.S. Provisional Application No. 60/238,166 filed Oct. 5, 2000, wherein the provisional application is incorporated herein by reference in its entirety.

The present invention relates generally to speech technology and in particular to the transmission of speech. Still more particularly the present invention relates to an improved method for the transmission of speech using a small amount of data.

Transmission of speech by digital techniques has become widespread, particularly in long distance and digital radio telephone applications. This, in turn, has created interest in determining the least amount of information that can be sent over the channel and still maintain the perceived quality of the reconstructed speech. If speech is transmitted by simply sampling and digitizing, a data rate on the order of 64 kilobits per second (kbps) is required to achieve a speech quality of conventional analog telephone. However, through the use of speech analysis, followed by the appropriate coding, transmission, and resynthesis at the receiver, a significant reduction in the data rate can be achieved.

Devices which employ techniques to compress voiced speech by extracting parameters that relate to a model of human speech generation are typically called vocoders. Such devices are composed of an encoder, which analyzes the incoming speech to extract the relevant parameters, and a decoder, which resynthesizes the speech using the parameters it receives over the transmission channel. In order to be accurate, the model must be constantly changing. Thus the speech is divided into blocks of time, or analysis frames, during which the parameters are calculated. The parameters are then updated for each new frame.

The function of the vocoder is to compress the digitized speech signal into a low bit rate signal by removing all of the natural redundancies inherent in speech. Although the use of vocoding techniques reduce the amount of information sent over the channel while maintaining quality reconstructed speech, other techniques need be employed to achieve further reduction.

Since speech inherently contains periods of silence, i.e., pauses, the amount of data required to represent these periods can be reduced. Variable rate vocoding most effectively exploits this fact by reducing the data rate for these periods of silence. While several strides have been made in reducing the silence between words, a workable method to reduce the spoken words themselves has yet to be developed.

What is needed is a way to optimize the system by improving quality, while still retaining the relatively low data rate.

It is therefore one object of the present invention to provide an accurate representation of the spectrum content of a speech frame.

It is another object of the present invention to provide an improved method for the low data rate transfer of speech.

It is still another object of the present invention to provide an improved quality of the transfer of speech.

It is therefore an object of the present invention to provide a novel and improved method and system for the compression speech.

The foregoing objects are achieved as is now described.

Method and apparatus for reducing the amount of data sent when transmitting speech by obtaining the spectrum content of digital speech. First, analog speech is converted to digital speech. Then the digital speech is divided into frames and a spectrum analysis is performed on the frames. Frames with similar spectrum are combined. Then a second spectrum analysis is performed in predetermined steps. The data from the spectrum analysis of each frame is compressed and sent to a receiver. The receiver uses the data to reconstruct the frame. The frame is combined with other frames to reproduce the digital signal. Then the digital signal is played back, thereby reproducing the analog speech.

The above as well as additional objectives features, and advantages of the present invention will became apparent in the following detailed written description.

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

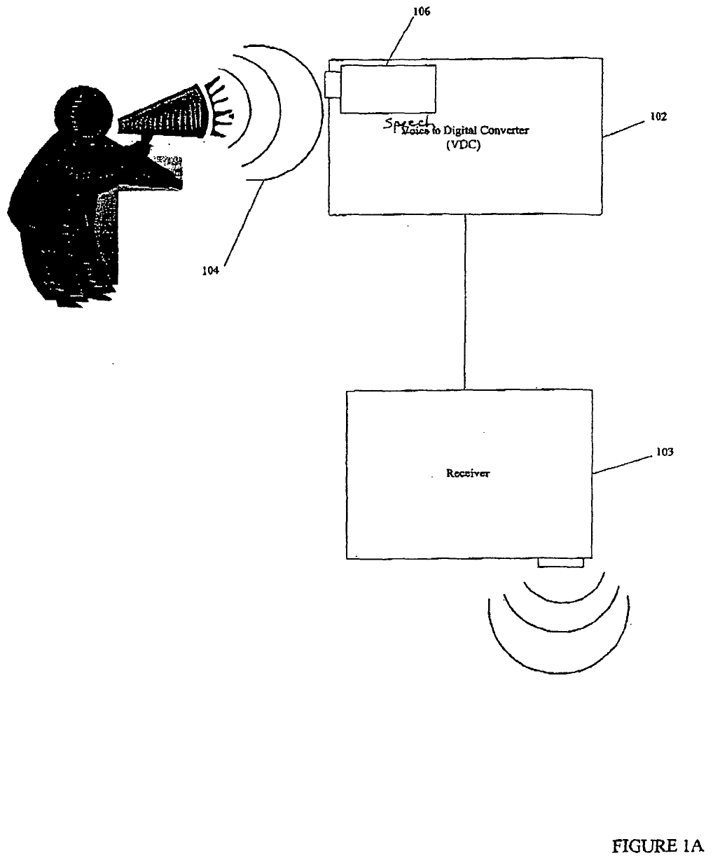

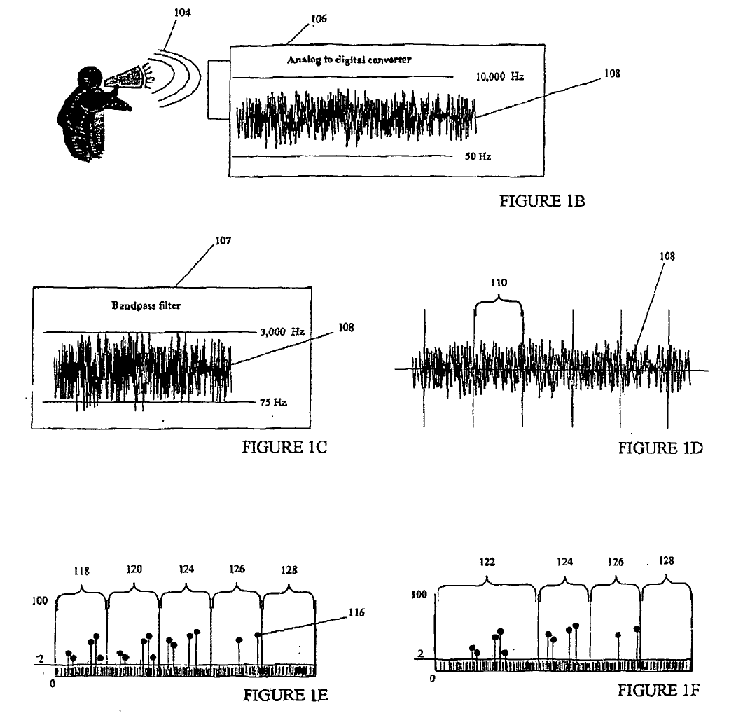

FIG. 1A depicts a block diagram of a speech to data converter in accordance with a preferred embodiment of the present invention;

FIG. 1B is a block diagram of an analog to digital converter commonly used;

FIG. 1C is a block diagram of a bandpass filter commonly used;

FIG. 1D depicts a block diagram of a digital signal divided into frames in accordance with a preferred embodiment of the present invention;

FIG. 1E depicts a block diagram of a series of frames after a spectral analysis has been performed in accordance with a preferred embodiment of the present invention;

FIG. 1F depicts a block diagram of a series of frames after a frame comparison has been performed in accordance with a preferred embodiment of the present invention;

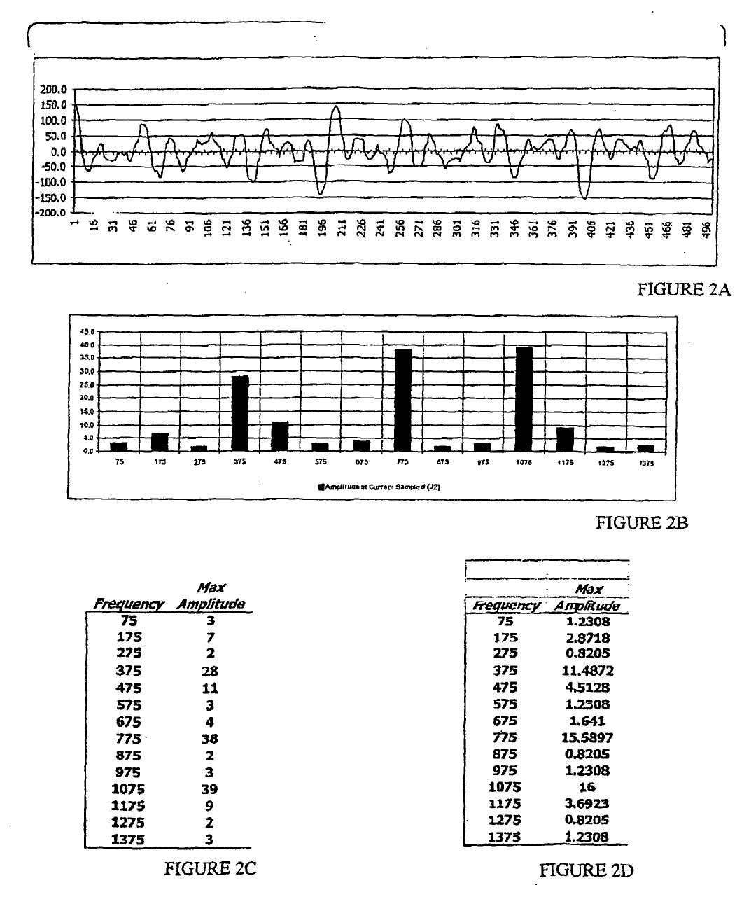

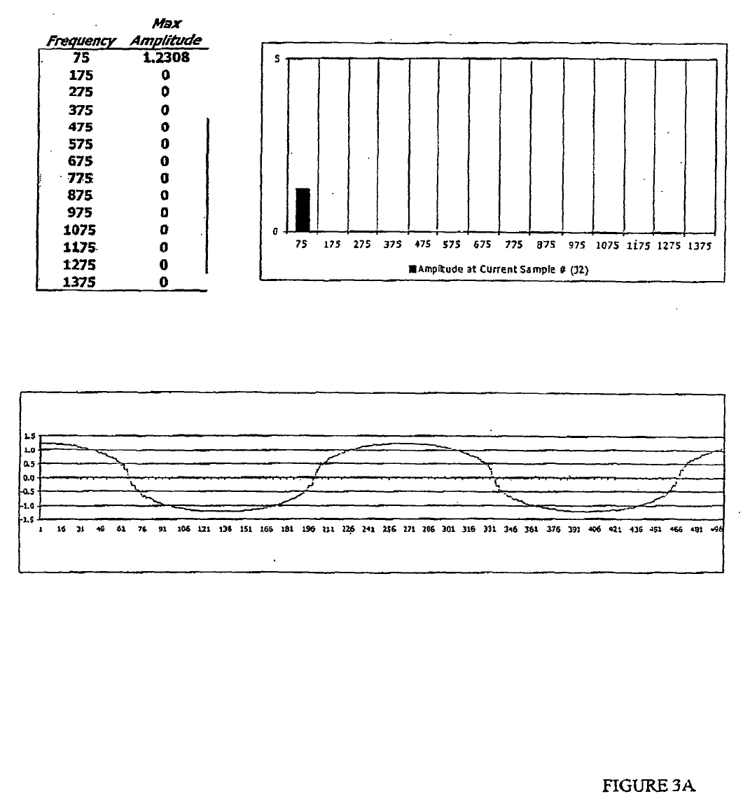

FIG. 2A depicts a block diagram of a frame before a spectral analysis has been performed in accordance with a preferred embodiment of the present invention;

FIG. 2B depicts a block diagram of the results of a spectral analysis in accordance with a preferred embodiment of the present invention;

FIG. 2C depicts a block diagram of the results of a spectral analysis where the amplitude is measured on a 0 to 100 unit scale in accordance with a preferred embodiment of the present invention;

FIG. 2D depicts a block diagram of the results of a spectral analysis where the amplitude is measured on a 0 to 16 unit scale in accordance with a preferred embodiment of the present invention;

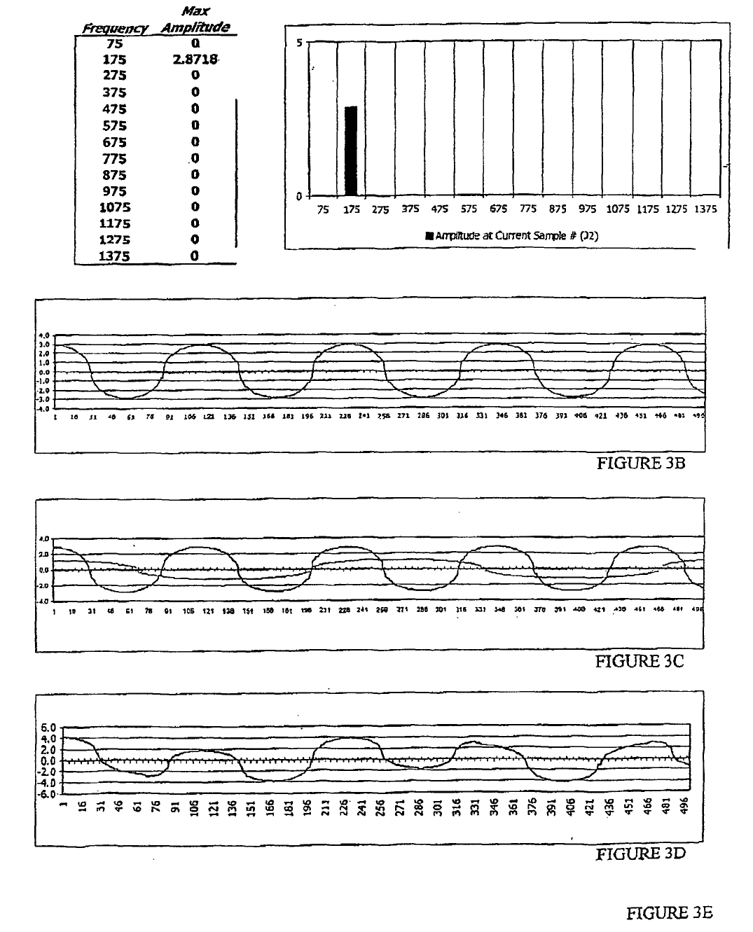

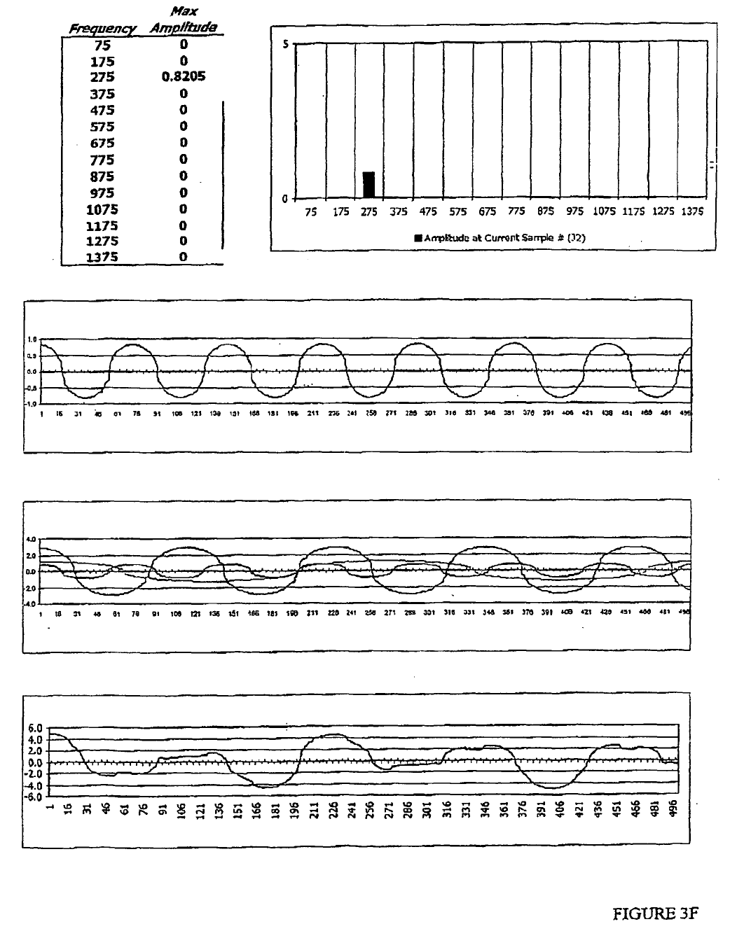

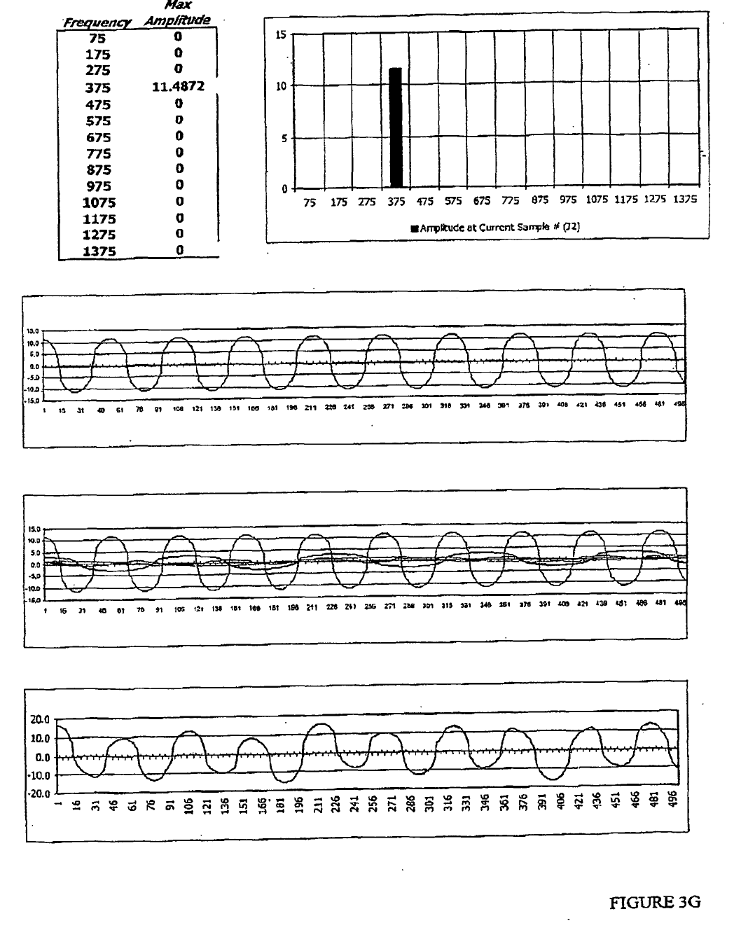

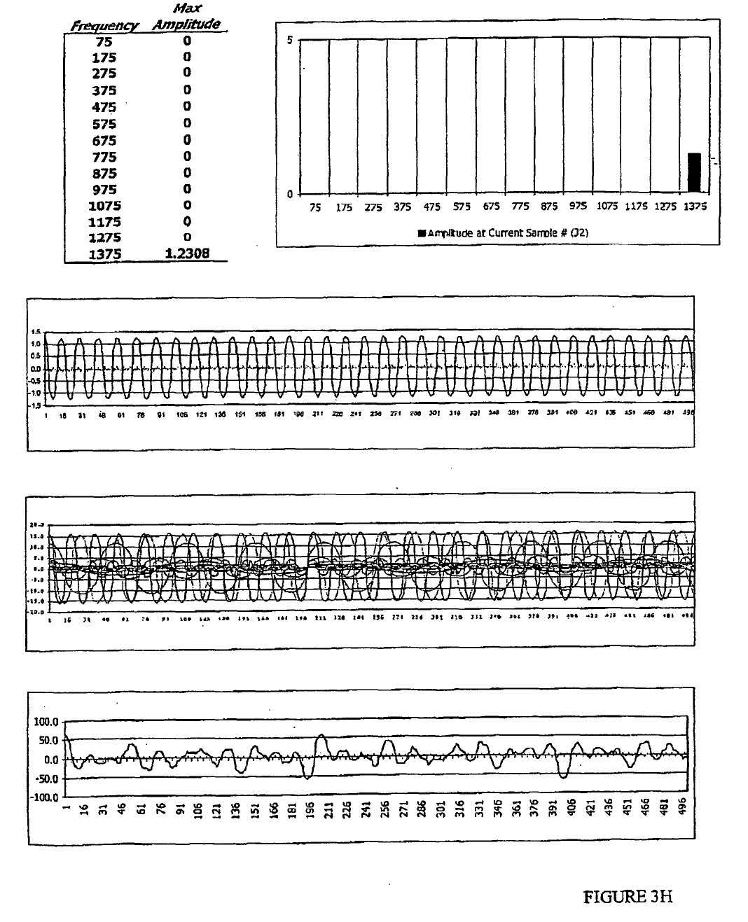

FIGS. 3A-H depict a block diagram of a sine wave for a specific frequency and resultant sine wave for a frame in accordance with a preferred embodiment of the present invention;

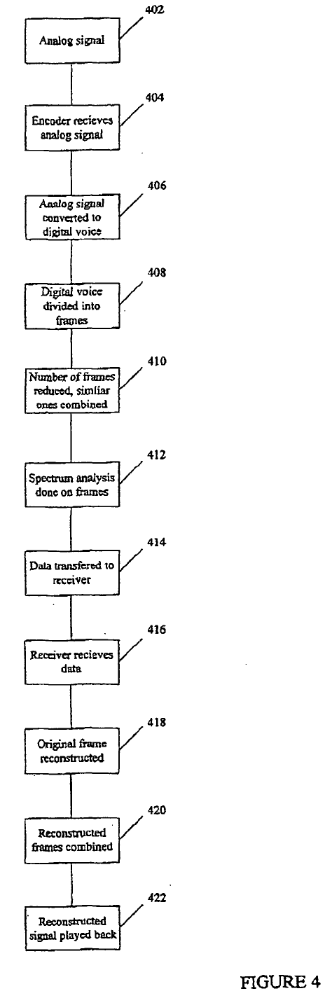

FIG. 4 depicts a flow chart showing the steps in the speech to data conversion in accordance with a preferred embodiment of the present invention; and

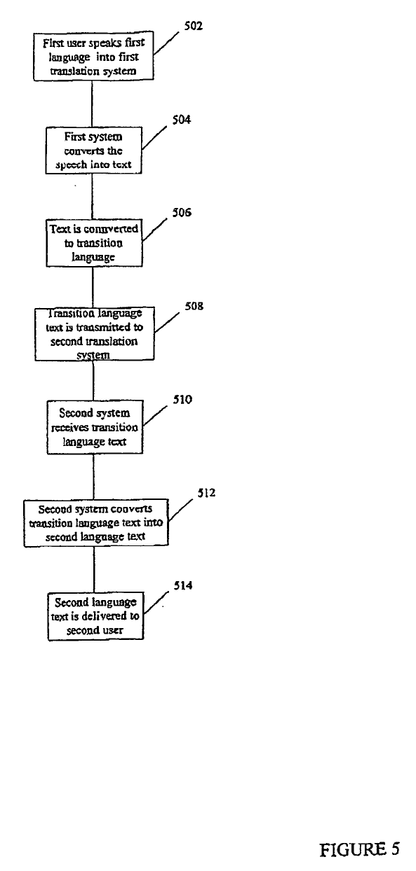

FIG. 5 depicts a flow chart showing the steps of a universal translator in accordance with a preferred embodiment of the present invention.

With reference now to the figures, and in particular with reference to Figure 1A, a block diagram of a speech to digital converter (VDC) 102 in accordance with the present invention. Analog signal 104 is received at encoder 106. As depicted in FIG. 1B, encoder 106 converts analog signal 104 into digital signal 108. This is done using an analog to digital converter and the process is common in the art. The analog signal is sampled at a rate of 500,000 to 1,000,000 times per second in 8 bits per sample. The frequency range is limited from about 50 Hz to 10,000 Hz. This range is greater than the system requires, but further narrowing of the frequency range will be done as explained below.

For telephone quality sound, the frequency range of digital signal 108 is further narrowed from about 75 Hz to about 3,000 Hz, as depicted in FIG. 1C. The narrowing of the frequence is done with bandpass filter 107 and the process is common in the art. Different frequency ranges can be used for different purposes.

Next, as shown in FIG. 1D, digital signal 108 is divided into frames 110 using a frame rate of about 150 frames per second. In order to reduce the amount of data to be transferred, a spectrum analysis is preformed on frame 110 and frames with similar spectrum are combined.

A fast Fourier transform (FFT) is used to perform the spectrum analysis and generate peaks similar to FIG. 1E. While the preferred embodiment is a range set at 50 Hz steps between 75 Hz and 3,000 Hz (3 kHz), almost any range can be used. The amplitude of each step is evaluated in 4 bits (16 levels) and once the analysis of each frame 110 is completed, all amplitudes below a level of 2 are deleted and the peak amplitudes are stored with their frequencies. FIG. 1E shows a series of frame 110s after a spectrum analysis has been performed on each one. Marks 116 illustrate the highest amplitudes for each frame.

In the preferred embodiment, a maximum number of five peaks are stored, however any number of peaks can be used. After the maximum amplitudes are determined, each frame is compared to the next frame. For example, frame 118 in FIG. 1E is compared to frame 120. If the data is relatively close then the two frames are combined. When one frame is different from the previous frame or from the general range of a series of frames or the total number of frames added together exceeds 15, then the frame is ended and the total number of frames added together is converted into a time slice. It is this time slice that will be analyzed for the data to be transmitted.

Because frame 118 and frame 120 are similar, a check is done to see if 15 frames have been combined into one frame that is similar to frames 118 and 120. If less than 15 frames have been combined into one, then frames 118 and 120 are combined into frame 122, shown in FIG. 1F. Next, frame 122 is compared to frame 124 to see if they are similar. If they are not, the length of frame 122 is recorded in the frame header. The process starts over and frame 124 is compared to frame 126.

Frame 128 represents a silence frame. Silence has a special length. Silence accounts from most of the speech signal, whether between words or sentences or while listening. Silence frames are given a length indicator of 16 frames, while speech frames use a maximum length of 15 frames. Only silence frames can have a length of 16 frames. This simplifies the data stream considerably as any frame with a frame length of 16 does not require additional processing. However, if a silence frame was less than 16 frames, then it would have to be analyzed and would require additional processing.

Next, frame 122 is analyzed for its spectral content area. A spectrum analysis is preformed on frame 122. FIG. 2A represents frame 122 before a spectral, analysis is performed. By analyzing for the spectral content of frame 122, the power distribution of frame 122 can be determined. The power distribution of each frame determines the sound for a particular frame. The better the power distribution is documented, the better the reproduction will be.

A FFT is used to do the spectrum analysis. A FFT is able to take all the power from a given range, for example 100 Hz, and represent the power distribution in terms of a sine wave. While almost any range can be set, in the preferred embodiment, the range is set at 100 Hz steps between 75 Hz and 3,000 Hz (3 k Hz). The bottom frequency is set at 75 Hz because most of the power distribution below 75 Hz is due to noise. The upper frequency is set at 3 kHz because human speech seldom extends above that area. A frequency lower than 3 kHz could be used, but pitch and timber would be lost. Other step sizes may be used so long as the steps are close enough to replicate speech at an acceptable level of quality. The larger the frequency steps, the fewer the data points sent. However, the fewer the data points sent, the poorer the reproduction quality of the receiver.

When plotting, or obtaining the data from the spectrum analysis, the amplitude is first plotted on an amplitude scale ranging from 0 to 100. Then the highest single amplitude is stored as the frames absolute amplitude. For example, the highest amplitude in FIG. 2B is 39 found at the 1075 frequency mark. Next, the area from 0 to the absolute amplitude is divided into 16 steps. For example, the maximum amplitude for frame 122 is 39 on a 0 to 100 units scale, the absolute amplitude is set at 39 as shown in FIG. 2C. Then the area from 0 to 39 is divided in 16 units. Each unit is equal to 2.4375 units on the 0 to 100 scale. The purpose of setting the maximum amplitude is maintain a 4 bit resolution no matter what the absolute amplitude of the frame is. Otherwise, frame resolution would be directly proportional to frame amplitude. By setting a maximum amplitude, the frame amplitude is independent of frame resolution. The absolute amplitude will be included in the frarne's header along with the length of the frame. By measuring in 16 unit steps, the least amount of data needed for proper resolution is sent to the receiver. The amplitude steps could be less, but that would require more data to be sent to the receiver. The amplitude steps could be greater, but quality would be sacrificed. FIG. 2C shows the amplitudes on a scale of 0 to 100 units. FIG. 2D shows the amplitudes after the maximum amplitude has been set at 39. It is the data from FIG. 2D that is sent to receiver 103.

The amplitude data for each of the 100 Hz steps will be included as part of the frame data. Up to 30 amplitudes will be required for each frame. However, in one embodiment, all amplitudes less than 2 units are eliminated. This results in most of the amplitude data being 0's. The number of bits for each frame will be about 6 bits to identify the frame start, 4 bits for frame length, 6 bits for absolute amplitude and 4 bits for each of up to 30 amplitudes. The result is a maximum of 136 bits per frame. If an increased reduction in data is required, then all amplitudes less than 2 units are eliminated. By using compression algorithms it will be possible to reduce the frame data by 60% to 80% or to about 25 to 55 bits per frame. With an average frame rate of about 18 to 20 frames per second, obtaining an average of 1,000 bits per second should be achievable. The data is sent to receiver 103 by conventional means known in the art.

Upon receipt of the data, receiver 103 reads the frame length and absolute amplitude from the frame header and assigns the amplitude from the correct frequency. Receiver 103 knows the frequency steps are in 100 Hz increments and, as depicted in FIGS. 3A-3H, creates a sine wave for each frequency step and corresponding amplitude. If played back, the single sine wave would merely produce a tone. To reproduce speech, the sine waves for each frequency step in the frame must be reproduced and combined with the other sine waves in the frame to form a resultant sine wave. For example, FIG. 3B represents the sine wave recreated from the amplitude that corresponds to frequency of 175 Hz. FIG. 3C depicts the recreated sine wave combined with the sine wave generated from the data that corresponds with 75 Hz. FIG. 3D represents the resultant sine wave from the combination of the two sine waves shown in FIG. 3C. The process is repeated as shown in FIGS. 3F-3H until all of the sine waves for the frame have been recreated and a resultant wave have been produced. The resultant wave is similar to the wave in FIG. 2A.

If played back by themselves, each frame would produce an unrecognizable sound or beep. However, when the frames are played in sequence, digital signal 108 is replicated. To eliminate the flutter caused by discontinuities, each frame is faded into the next or some other process known in the art is used.

The entire process is depicted ire FIG. 4. Block 402 illustrates the production and propagation of analog signal 104. Block 404 depicts encoder 106 receiving analog signal 104. Block 406 illustrates encoder 106 converting analog signal 104 into digital signal 108. Block 408 depicts digital signal 108 being divided into frame 110s. Block 410 illustrates the length of frame 110s being reduced by combining similar frame 110s. Block 412 depicts a spectrum analysis being performed on frame 110. Block 414 illustrates the frame data being send to receiver 103. Block 416 depicts receiver 103 receiving the frame data. Block 418 illustrates receiver 103 reconstructing the frame based on the frame data send. Block 420 depicts the reconstructed frames being combined to reproduce digital signal 108. Block 422 illustrates the reconstructed digital signal 108 being played back as analog signal 104.

FIG. 5 depicts the use of a universal translator. Block 502 illustrates a first user speaking a first language into a first translation system. First translation system is any translation system that can convert one language in text into the text of a single transition language. It is preferable that the translation System also has speech recognition, but it is not required. Block 504 depicts converting the first language speech into first language text. Block 506 illustrates the text in first language being converted into text in a transition language. In the preferred embodiment the transition language is English, however, any language could be used. Block 508 depicts the text of transition language being transmitted to a second translation system. The requirements for the second translation system are the same as those for the first translation system. Block 510 illustrates the second translation system receiving the text of transition language. Block 512 depicts the second language system converting the transition language text into a second language text. Block 514 illustrates the second language text being delivered to the second user. In another embodiment, after the text is delivered to the second user, the second language text could be translated back into the transition language, then back into first language text. This would allow the first user to see how the translations effected first user's meaning.

Each translation system only has to convert a language into the translation language or the translation language to the user's language. Consequently, the translation system can be focused to deliver a true translation of grammar and vocabulary instead of translating more than one language. As a result, a much more accurate speech translation system would be developed.

We claim:

1. A method for communicating data, comprising the steps of:
receiving a data stream;
converting the data stream to at least a first frame and a second frame;
performing a Fast Fourier Transform (FFT) on the first frame resulting in a first FFT frame and the second frame resulting in a second FFT frame;
converting the first FFT frame and the second FFT frame into a combined FFT frame, if the first FFT frame and the second FFT frame are similar; and
transmitting a single packet representing the combined FFT frame,
otherwise transmitting a first packet representing the first FFT frame and a second packet representing the second FFT frame.

2. The method of claim 1, wherein transmitting the single packet, further comprising the step of transmitting data in the first FFT frame in the single packet.

3. The method of claim 1, wherein transmitting the single packet, further comprising the step of transmitting data in the second FFT frame in the single packet.

4. The method of claim 1, wherein transmitting the first packet further comprising the step of transmitting data in the first FFT frame in the first packet and transmitting the second packet further comprising the step of transmitting data in the second FFT frame in the second packet.

5. The method of claim 1, wherein the data stream is filtered through a band-pass filter.

6. The method of claim 5, wherein the step of transmitting the single packet, further comprising the steps of:
ascertaining power amplitudes at certain frequencies in the combined FFT frame;
discarding power amplitudes at the certain frequencies below a threshold in the combined FFT frame; and
inserting resultant power amplitudes at the certain frequencies in the combined FFT frame into the single packet.

7. The method of claim 6, wherein the resultant power amplitudes are the power amplitudes divided by a highest amplitude of the combined FFT frame.

8. The method of claim 7, wherein the step of preparing the single packet for transmission, further comprising the step of inserting corresponding frequencies with the resultant power amplitudes into the single packet.

9. The method claim 7, wherein the certain frequencies are in a frequency band between 75 Hertz and 3000 Hertz.

10. The method of claim 7, wherein the certain frequencies are in a frequency band between 75 Hertz and 3000 Hertz in frequency steps of 100 Hertz.

11. The method of claim 7, wherein the threshold is 2.

12. The method of claim 7, wherein the data stream is an analog voice signal.

13. A communication system, comprising:
an input receiving speech and providing a data stream;
an encoder coupled to the input to receive the data stream and provide an output comprising packets to a transmitter,
wherein the encoder is adapted to convert the data stream to at least a first frame and a second frame, perform a Fast Fourier Transform (FFT) on the first frame resulting in a first FFT frame and the second frame resulting in a second FFT frame, convert the first FFT frame and the second FFT frame into a combined FFT frame, if the first FFT frame and the second FFT frame are similar, and provide a single packet representing the combined FFT frame to the transmitter, otherwise provide a first packet representing the first FFT frame and a second packet representing the second FFT frame to the transmitter.

14. The communication system of claim 13, wherein the encoder includes a band-pass filter.

15. The communication system of claim 14, wherein the single packet includes resultant power amplitudes at certain frequencies in the combined FFT frame.

16. The communication system of claim 15, wherein the resultant power amplitudes are power amplitudes divided by a highest amplitude of the combined FFT frame.

17. The communication system of claim 15, wherein the single packet furthers includes corresponding frequencies with the resultant power amplitudes.

18. The communication system of claim 16, wherein the certain frequencies are in a frequency band between 75 Hertz and 3000 Hertz.

19. The method of claim 16, wherein the certain frequencies are in a frequency band between 75 Hertz and 3000 Hertz in frequency steps of 100 Hertz.

20. A method for translating data, comprising the steps of:
converting a first speech into a first data;
converting the first data into a base transition data;
converting the base transition data to a second data; and
converting a second data to a second speech.

21. The method of claim 20, wherein the first data and the second data are text data.

22. The method of claim 21, wherein the base transition data is non-English data.

23. The method of claim 22, wherein the first speech is a French language and the second speech is an English language.
